(19) United States
(12) Patent Application Publication
(10) Pub. No.: US 2009/0216618 A1
(43) Pub. Date: Aug. 27, 2009

(54) Launch Monitoring System of Network Advertisement and the Method Thereof

(76) Inventor: Han CHEN, Shenzhen (CN)

Correspondence Address: TROXELL LAW OFFICE PLLC, 5205 LEESBURG PIKE, SUITE 1404, FALLS CHURCH, VA, 22041, US

(21) Appl. No.: 12/351,346

(22) Filed: Jan. 9, 2009

(30) Foreign Application Priority Data
Feb. 1, 2008 (CN) 200810066018.6

(51) Int. Cl. G06Q 30/00; G06Q 99/00

(52) U.S. Cl. 705/10; 705/14; 705/30

(57) ABSTRACT

The present invention discloses a launch monitoring system of network advertisement and the method thereof, comprising: multiple advertisement browsing terminals; an advertisement management unit; an investigation information generating unit, for generating investigation information about the content of the advertisement data sent to the advertisement browsing terminal by the advertisement management unit and sending the investigation information to the advertisement browsing terminals as the form of investigation essay question; an investigation evaluation unit, for evaluating the answers made by the advertisement browser to the investigation information via the advertisement browsing terminals and generating an evaluation result; a browsing reward executing unit connected to the investigation evaluation unit and the advertisement browsing terminals, for giving rewards to the advertisement browser in accordance with the evaluation result generated by the investigation evaluation unit. The present invention can accurately evaluate and count the valid advertisement clicks, and not only provides the advertiser with the evaluation basis for the validity of launching advertisement, but also provides reference basis for the advertiser to pay the advertisement expense to the network communication media operators.

### BACKGROUND OF THE INVENTION

1. Field of the Invention

The present invention relates to a launch and management system of network advertisement, especially relates to a launch monitoring system of network advertisement and the method thereof, which investigates and evaluates in interactive mode the effect of the advertisement browser browsing advertisements.

2. Description of the Prior Art

Launching advertisements by traditional communication medias, such as TV, news paper, the advertiser or the media operator has no way to know on earth how many advertisement receivers really pay attention to and know the advertisement, that is, neither the advertiser nor the media operator can give exact evaluation and judgment about the effectiveness of launching the advertisement, so, this will greatly increase the risk of advertisement launch. Besides, in the process of launching traditional advertisements, just because after the advertisement is launched the advertiser never can accurately monitor the real browsing amount and the propaganda effect after browsing, so ad to a great deal of advertisement investments are wasted. According to statistical data, in the world every year the expense wasted on invalid advertisements approaches nearly 5 hundred billion US dollar.

With the popularization of the Internet and the development of information technology, the service of network advertisement also develops rapidly. Wherein the network click advertisement solves the problem quite well to monitor the browsing amount after the advertisement is launched, and the network click advertisement is a advertisement service mode that the advertisers pay the advertisement expenses to the network communication media operators basing on the click amount of their advertisements launched at the network communication media being clicked by the browser. For example, the search engine Baidu (www.baidu.com) is just an example to charge advertisement expense basing on the click amount of the users.

According to current network service mode and advertisement launch mode, if only the network advertisement of the advertiser is clicked by the browser, no matter the browser really has browsed the content of the advertisement or not, the advertiser at all times needs to pay the advertisement expense to the network communication media operator. Although comparing this network advertisement launch mode with the traditional advertisement launch mode, network click advertisement has the advantage of being able to calculate out exactly how many people has clicked the advertisement through the network, but it still has disadvantages of below said: the network communication media operator or the advertiser can only know how many people has clicked the advertisement, but can not give exact evaluation and statistic about whether the click is valid or not, or whether the advertisement click represents the advertisement content being known or not. Besides, some lawbreakers will do click fraud to a website by programming, which will cause the loss of the advertiser.

### SUMMARY OF THE INVENTION

The object of the present invention is to solve the technical problem of currently being incapable to give exact evaluation and statistic about the valid advertisement click representing really knowing the advertisement content, and provides a launch monitoring system of network advertisement and the method thereof, which investigates and evaluates in interactive mode the effect of the advertisement browser browsing advertisements launched through network.

The present invention bases on Internet platform and database technology, and improves the accounting and statistical method of conventional network click advertisement; a remote database system according to the advertisement content clicked by the browser automatically poses questions relating to the advertisement content, and gives rewards in accordance with the results answered by the browser, and the result of the rewards is recorded/updated in the database. By investigating the advertisement browsers in interactive mode, the valid advertisement clicks can be accurately evaluated and counted, which not only provides the advertiser with the evaluation basis for the validity of launching advertisement, but also provides reference basis for the advertiser to pay the advertisement expense to the network communication media operators.

The launch monitoring system of network advertisement disclosed in the present invention comprises: multiple advertisement browsing terminals; an advertisement management unit connected to the advertisement browsing terminals through a network, for sending stored advertisement data to the advertisement browsing terminals and controlling the advertisement data to unfold through the advertisement browsing terminals; an investigation information generating unit connected to the advertisement management unit, for generating investigation information about the content of the advertisement data sent to the advertisement browsing terminal by the advertisement management unit and sending the investigation information to the advertisement browsing terminals as the form of investigation essay question/choice question; an investigation evaluation unit connected to the investigation information generating unit and the advertisement browsing terminals, for evaluating the answers made by the advertisement browser to the investigation information via the advertisement browsing terminals; a browsing reward executing unit connected to the investigation evaluation unit and the advertisement browsing terminals, for giving rewards to the advertisement browser in accordance with the evaluation result generated by the investigation evaluation unit. The browsing reward executing unit is provided with a memorizer storing the evaluation result, and the browser can query the memorizer.

In a preferred embodiment of the present invention, the investigation information may be essay questions, choice questions, and the time or web page amount of browsing the advertisement in accordance with the advertisement content; the method of implementing encouraging the advertisement browser has many manifestations, and may be currencies in real life, cinema tickets, lottery tickets, network visual value capable of paying for the network expense of the advertisement browser, coupons used in real life, or even network visual currencies capable of buying visual network goods, etc., so as to encourage the advertisement browser to assist finishing the advertisement investigation according to the knowing advertisement content thereof after browsing the advertisement content. By investigating the advertisement browsers in interactive mode and according to the feedback of the advertisement browser about the investigation result, the present invention can accurately evaluate and count the valid advertisement clicks, and accurately get hold of the advertisement browsing amount of actual knowing the advertisement content.

The preferred embodiment of the present invention also can comprise an advertisement accounting unit connected to the investigation evaluation unit, for implementing accounting and storing of the advertisement according to the evaluation result generated by the investigation evaluation unit. The advertisement accounting unit provides the advertiser with reference basis to pay the advertisement expense to the network communication media operators. The advertisement accounting unit may be provided with a memorizer storing the evaluation result, and the advertiser can query the memorizer.

The preferred embodiment of the present invention also can comprise an advertisement launch unit connected to the advertisement management unit, for launching/updating the advertisement data to the advertisement management unit. The network communication media operator or the advertiser can update the advertisement data content via the advertisement launch unit at any moment, having the advantage of convenient operation.

The advertisement management unit of the present invention is an Internet website, a cell phone WAP website having the ability of managing programs at the server, and all the servers having the function of remote login of the user and having advertisement management programs running thereof; all the advertisements are in the form of advertisement link points to be centralized to display on a user interface of the advertisement management unit, and the advertisement data corresponding to the advertisement link point clicked by the advertisement browser via the advertisement browsing terminals is sent to the advertisement browsing terminals and controlled to unfold by the advertisement management unit; or, certain advertisement data is sent to the advertisement browsing terminals logging in connected to the advertisement management unit and controlled to unfold by the advertisement management unit.

The present invention also discloses a launch monitoring method of network advertisement, comprising below said steps: sending the stored advertisement data via network to one or multiple advertisement browsing terminals, and controlling the advertisement data to unfold through the advertisement browsing terminals; generating investigation information about the content of the advertisement data sent to the advertisement browsing terminals, then sending the investigation information to the advertisement browsing terminals; evaluating the answers made by the advertisement browser to the investigation information via the advertisement browsing terminals, and generating the evaluation result; giving rewards to the browser in accordance with the evaluation result.

The preferred embodiment of the present invention also comprises the step of implementing accounting and storing of the advertisement according to the evaluation result.

All the advertisements are in the form of advertisement link points to be centralized to display on a user interface, and the advertisement data corresponding to the advertisement link point clicked by the advertisement browser via the advertisement browsing terminals is sent to the advertisement browsing terminals and controlled to unfold; or, certain advertisement data is sent to the advertisement browsing terminals and controlled to unfold.

In another embodiment of the present invention, the launch monitoring method of network advertisement comprises below said steps:

according to the registration information of the browser, searching, invoking stored advertisement data related to the registration information, then sending the stored advertisement data via network to the registration advertisement browsing terminals, and controlling the advertisement data to unfold through the advertisement browsing terminals;

generating investigation information about the content of the advertisement data sent to the advertisement browsing terminals, and sending the investigation information to the advertisement browsing terminals;

evaluating the answers made by the advertisement browser to the investigation information via the advertisement browsing terminals, and storing the evaluation result;

giving rewards to the advertisement browser in accordance with the evaluation result.

Comparing with the conventional art, the present invention has the below said advantages:

by investigating the advertisement browsers in interactive mode and according to the feedback of the advertisement browser about the investigation result, the present invention can accurately evaluate and count the valid advertisement clicks, and accurately get hold of the advertisement browsing amount of actual knowing the advertisement content. So, the present invention implements monitoring the validity of launching advertisement, at the same time, the present invention not only provides the advertiser with the evaluation basis for the validity of launching advertisement, but also provides reference basis for the advertiser to pay the advertisement expense to the network communication media operators. Further more, for a predetermined program can mot deal with a random questionnaire, click fraud will be avoided.

### BRIEF DESCRIPTION OF THE DRAWINGS

FIG. 1 is a structure schematic diagram of a preferred embodiment of the present invention;

FIG. 2 is a flow schematic diagram of a preferred embodiment of the present invention.

### DESCRIPTION OF THE PREFERRED EMBODIMENT

The present invention utilizes the characteristic of remotely transmitting and storing data of Internet platform and the information database. After the browser clicks the advertisement, the system automatically asks the browser to answer questions relating to the advertisement content, and by means of giving rewards for right answers, the browsers are engaged to initiatively answer the questions, so as to complete a man-computer interaction conversation. Then, the system generates, gathers the interacting result data, to provide to the advertiser as a monitoring method for the validity of advertisement launch. So, the problem is effectively solved that whether it is actually browsed by the browser or not after the network advertisement is launched.

The present invention aims at network advertisements launched on the Internet. Investigation information about the advertisement content is generated according to the advertisement obtained by an advertisement browser, and may be provided to the advertisement browser as a questionnaire to get an investigation result finished by the advertisement browser. The investigation result is analyzed and processed to get an evaluation result. According to the evaluation result, the advertisement browsing amount of actual knowing the advertisement content is accurately gotten hold of, which not only provides the advertiser with the evaluation basis for the validity of launching advertisement, but also provides reference basis for the advertiser to pay the advertisement expense to the network communication media operators.

In the present invention, the advertiser pays advertisement expense or advertisement service expense according to a certain basis to the network communication media operator providing network advertisement communication service, and the expense comprises the a reward expense paid to the browser.

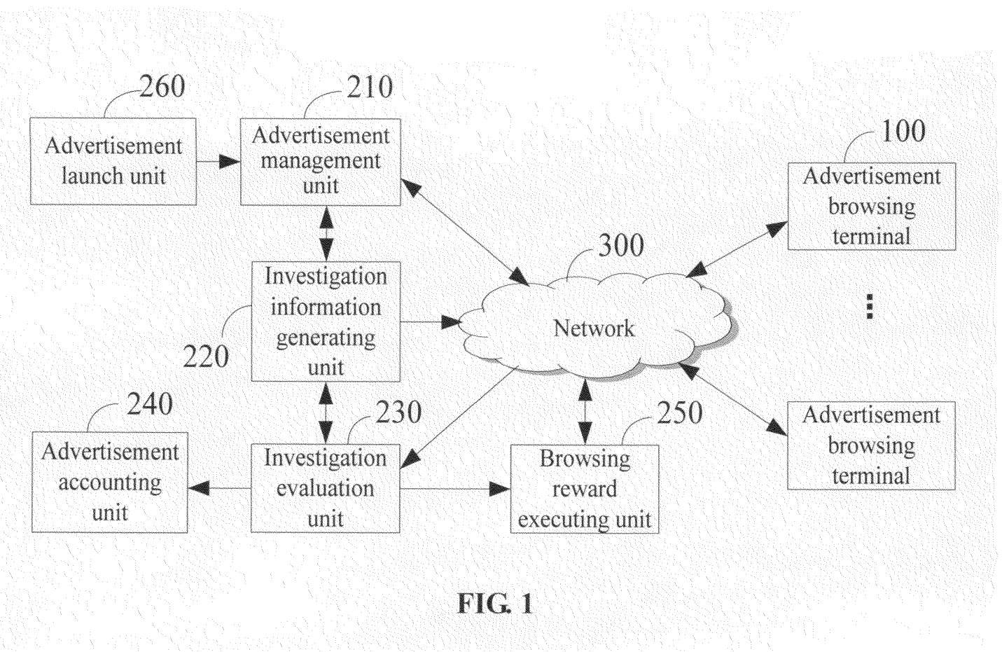

Referring to FIG. 1, the advertisement system of interactive mode of the present embodiment comprises: some advertisement browsing terminals 100; an advertisement management unit 210 connected to the advertisement browsing terminal 100 through a network 300, an investigation information generating unit 220, an investigation evaluation unit 230, an advertisement accounting unit 240, a browsing reward executing unit 250, and an advertisement launch unit 260 connected to the advertisement management unit 210.

The network 300 has multiple forms, such as the Internet, a digital TV network, a wireless network connected to the Internet, a LAN, an Ethernet network and a visual LAN. So, the advertisement browsing terminal 100 may be a computer on the Internet, or be a digital TV receiver, or even be a cell phone, etc.

The advertisement management unit 210 is used to send stored advertisement data to the advertisement browsing terminal 100, and control the advertisement data to unfold through the advertisement browsing terminal 100. Wherein, all the advertisements are in the form of advertisement link points to be centralized to display on a user interface in the advertisement management unit 210, and the advertisement management unit 210 can send the corresponding advertisement data to the advertisement browsing terminal 100 and control unfolding, according to the advertisement link point clicked by the advertisement browser via the advertisement browsing terminal 100; the advertisement management unit 210 can also be in voluntary way to send certain advertisement data to the advertisement browsing terminal 100 and control unfolding. The advertisement management unit 210 is such as a server capable of remote login, a website or a WAP website for the cell phone users; the format of the advertisement data is such as multiple data formats of text, image, audio, video, Flash animation or a format combined of multiple formats.

Besides, for the advertiser or the network communication media operator to update the advertisement data stored in the advertisement management unit 210 at any moment, the present embodiment also comprises the advertisement launch unit 260 connected to the advertisement management unit 210, used to launch the advertisement data to the advertisement management unit 210. The advertisement launch unit 260 not only can send the updated advertisement data to the advertisement management unit 210, but also can control to generate advertisement link points on the user interface of the advertisement management unit 210 corresponding to the updated advertisement data.

The investigation information generating unit 220 is connected to the advertisement management unit 210 for generating investigation information about the content of the advertisement data sent by the advertisement management unit 210 to the advertisement browsing terminal 100, then the investigation information is sent to the advertisement browsing terminal 100 as investigation essay questions.

The investigation evaluation unit 230 is connected to the investigation information generating unit 220 and the advertisement browsing terminal 100, for evaluating the answers made by the advertisement browser to the investigation information via the advertisement browsing terminal 100, and generating the evaluation result.

For example, an advertisement browser clicks an advertisement link point via the advertisement browsing terminal 100, then obtains and watches a network advertisement of video format for the product of Milk Deluxe from Inner Mongolia Meng Niu Dairy (Group) Co.; the investigation information generating unit 220 control generating investigation information about the content of the advertisement, such as generating a choice question: the question is “Milk Deluxe has sound quality, because Milk Deluxe is produced from?”, the options are “A. the Inner Mongolian prairie; B. China diary city Xilinguole; C. Hohhot”. After the advertisement is played, the choice question is in web page mode via the advertisement browsing terminal 100 to unfold to the user; for the right answer B has clearly been shown during playing the advertisement, if only the browser really has seen the advertisement, the right choice can be made according to the content of the advertisement known by himself, and the choice result will be sent to the investigation evaluation unit 230 as a feedback. The investigation evaluation unit 230 receives the selection result and then implements comparative analysis with the right answer, so as to judge the advertisement click of the browser of this time is whether a valid advertisement click actually knowing the advertisement content or not. Of course, properly multiple investigation essay questions can be provided, so as to decrease the probability of the advertisement browser randomly guessing the selection answer to disturb the investigation evaluation.

So, by investigating the advertisement browsers in interactive mode and according to the feedback of the advertisement browser about the investigation result, the present invention can accurately evaluate and count the valid advertisement clicks, and accurately get hold of the advertisement browsing amount of actual knowing the advertisement content.

Besides, the advertisement accounting unit 240 is connected to the investigation evaluation unit 230, for implementing storing according to the evaluation result generated by the investigation evaluation unit 230, and implementing accounting of the advertisement. For example, the advertiser can pay advertisement expense or advertisement service expense to the network communication media operator according to the amount of the valid advertisement click, avoiding paying additional advertisement service expense for fraud advertisement clicks. So, the present invention accurately gets hold of the advertisement browsing amount of actually knowing the advertisement content, and provides reference basis for the advertiser to pay the advertisement expense to the network communication media operators.

Furthermore, the browsing reward executing unit 250 is connected to the investigation evaluation unit 240 and the advertisement browsing terminal 100, for executing encouragement to the advertisement browser for their browsing the advertisement, according to the evaluation result generated by the investigation evaluation unit 240, and the amount or time of the advertisement browser browsing the advertisement via the advertisement browsing terminal 100. Wherein, the content of the encouragement has many manifestations, such as currencies in real life, network visual value capable of paying for the network expense of the advertisement browser, coupons used in real life, or even network visual currencies capable of buying visual network goods. The object of the encouragement is merely to encourage the advertisement browser to assist finishing the advertisement investigation according to the knowing advertisement content thereof after browsing the advertisement content.

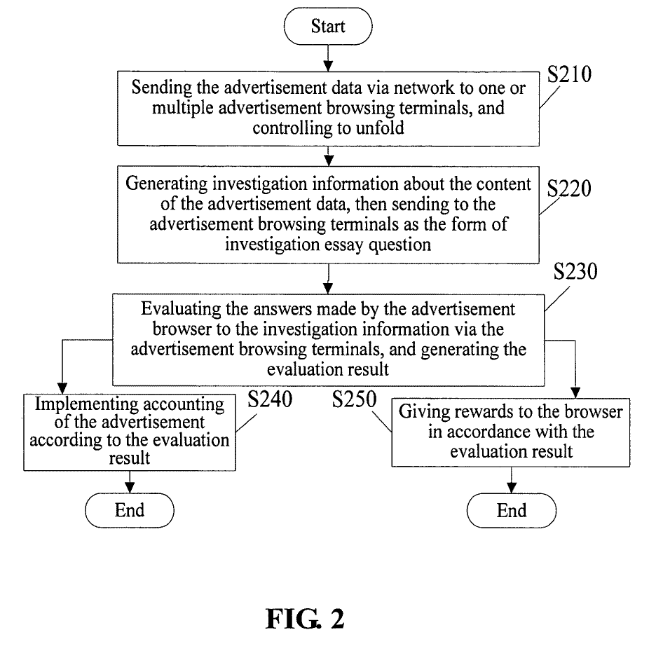

Referring to FIG. 2, a launch monitoring method of network advertisement of the present embodiment comprises below said steps:

Step S210: sending the stored advertisement data via network to one or multiple advertisement browsing terminals, and controlling the advertisement data to unfold through the advertisement browsing terminals;

Step S220: generating investigation information about the content of the advertisement data sent to the advertisement browsing terminal, then sending the investigation information to the advertisement browsing terminal as the form of investigation essay question;

Step S230: evaluating the answers made by the advertisement browser to the investigation information via the advertisement browsing terminal, and generating the evaluation result;

Step S240: recording the evaluation result, and implementing accounting of the advertisement according to the evaluation result;

Step S250: recording the evaluation result, and giving rewards to the browser in accordance with the evaluation result.

Otherwise, in the launch monitoring method of network advertisement of the present embodiment, the investigation information may be essay questions, choice questions, and the time or web page amount of browsing the advertisement in accordance with the advertisement content; the rewards to the advertisement browser may be visual network currencies, games, also may be currencies or goods in real life, so as to encourage the advertisement browser to assist finishing the advertisement investigation according to the knowing advertisement content thereof after browsing the advertisement content.

In another embodiment of the present invention, the browsers can register first, and according to the registration information of the browser, the advertisement management unit 210 will search, invoke stored advertisement data related to the registration information, then send the stored advertisement data via network to the registration advertisement browsing terminals, and control the advertisement data to unfold through the advertisement browsing terminals; then, the advertisement management unit 210 will generate investigation information about the content of the advertisement data sent to the advertisement browsing terminals, and send the investigation information to the advertisement browsing terminals; then the answers made by the advertisement browser to the investigation information via the advertisement browsing terminals are evaluated, and the evaluation result is stored; finally the advertisement browsers are rewarded in accordance with the evaluation result.

In practical operation, three-party operation mode can be adopted, wherein, the advertiser being a party, the network media operator being a party, the browser being a party, the advertisement management unit 210, the investigation information generating unit 220, the investigation evaluation unit 230, the browsing reward executing unit 250, and the advertisement accounting unit 240 being settled at the network media operator, and at this moment, the rewards paid by the advertiser may be directly paid to the browser in form of currencies, instead of being paid to the network advertisement media operator; four-party operation mode can also be adopted, and at this moment, the network media operator can cooperate with some famous websites, to provide the advertiser with value added service.

In conclusion, by investigating the advertisement browsers in interactive mode and according to the feedback of the advertisement browser about the investigation result, the present invention can accurately evaluate and count the valid advertisement clicks, and accurately get hold of the advertisement browsing amount of actual knowing the advertisement content, so, the present invention implements monitoring the validity of launching advertisement, at the same time, the present invention not only provides the advertiser with the evaluation basis for the validity of launching advertisement, but also provides reference basis for the advertiser to pay the advertisement expense to the network communication media operators.

What is claimed is:

1. A launch monitoring system of network advertisement comprising:
a plurality of advertisement browsing terminals;
an advertisement management unit connected to the advertisement browsing terminals through a network, for sending stored advertisement data to the advertisement browsing terminals and controlling the advertisement data to unfold via the advertisement browsing terminals;
an investigation information generating unit connected to the advertisement management unit, for generating investigation information about the content of the advertisement data and sending the investigation information to the advertisement browsing terminals;
an investigation evaluation unit connected to the investigation information generating unit and the advertisement browsing terminals, for evaluating the answers made by the advertisement browser to the investigation information; and
a browsing reward executing unit connected to the investigation evaluation unit and the advertisement browsing terminals, for giving rewards to the advertisement browser in accordance with the evaluation result generated by the investigation evaluation unit.

2. The launch monitoring system of network advertisement of claim 1, wherein the browsing reward executing unit is provided with a memorizer recording the investigation evaluation result, and the browser can query the memorizer.

3. The launch monitoring system of network advertisement of claim 1 wherein an advertisement accounting unit is connected to the investigation evaluation unit, for implementing accounting of the advertisement according to the evaluation result generated by the investigation evaluation unit.

4. The launch monitoring system of network advertisement of claim 3, wherein the advertisement accounting unit is provided with a memorizer recording the investigation evaluation result, and the advertiser can query the memorizer.

5. The launch monitoring system of network advertisement of claim 1, wherein the investigation information is essay questions, choice questions, the time of browsing the advertisement, or the web page amount of browsing the advertisement.

6. The launch monitoring system of network advertisement of claim 1, further comprising an advertisement launch unit connected to the advertisement management unit, for launching or updating the advertisement data to the advertisement management unit.

7. The launch monitoring system of network advertisement of claim 1, wherein the advertisement management unit is a server capable of remote login, a website or a WAP website for cell phone users;
all the advertisements are in the form of advertisement link points to be centralized to display on a user interface of the advertisement management unit, and the advertisement management unit being in accordance with advertisement link points clicked by the advertisement browser via the advertisement browsing terminals, sends the advertisement data corresponding to the advertisement link points to the advertisement browsing terminals and controls the advertisement data to unfold;
or, the advertisement management unit sends certain advertisement data to the advertisement browsing terminals logging in connected to the advertisement management unit and controls to unfold.

8. A launch monitoring method of network advertisement comprising:
sending the stored advertisement data via network to one or multiple advertisement browsing terminals, and controlling the advertisement data to unfold through the advertisement browsing terminals;
generating investigation information about the content of the advertisement data sent to the advertisement browsing terminal, and sending the investigation information to the advertisement browsing terminals;
evaluating the answers made by the advertisement browser to the investigation information via the advertisement browsing terminals, and storing the evaluation result; and
giving rewards to the browser in accordance with the evaluation result.

9. The launch monitoring method of network advertisement of claim 8, further comprising the step of implementing accounting and storing of the advertisement according to the evaluation result.

10. The launch monitoring system of network advertisement of claim 8, wherein the investigation information is essay questions, choice questions, the time of browsing the advertisement, or the web page amount of browsing the advertisement.

11. A launch monitoring method of network advertisement comprising below said steps:
according to the registration information of the browser, searching, invoking stored advertisement data related to the registration information, then sending the stored advertisement data via network to the registration advertisement browsing terminals, and controlling the advertisement data to unfold through the advertisement browsing terminals;
generating investigation information about the content of the advertisement data sent to the advertisement browsing terminals, and sending the investigation information to the advertisement browsing terminals;
evaluating the answers made by the advertisement browser to the investigation information via the advertisement browsing terminals, and storing the evaluation result;
giving rewards to the advertisement browser in accordance with the evaluation result.
